(19) United States
(12) Patent Application Publication
(10) Pub. No.: US 2009/0328117 A1
(43) Pub. Date: Dec. 31, 2009

(54) Network Based Management of Visual Art

(75) Inventors: Scott Morris, Decatur, GA (US); Michael Christian Boatright, Decatur, GA (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/146,322

(22) Filed: Jun. 25, 2008

(51) Int. Cl. H04N 7/173; H04N 5/445

(52) U.S. Cl. 725/105; 725/40

(57) ABSTRACT

Works of visual art are provided over a digital television provider network for local display by a user. Live or substantially live video of works of visual art may be streamed to the user's location. Alternatively, still images of the works of visual art may be captured and stored as electronic files. Network-based servers may feed the streaming video or electronic data from still images to one or more set-top boxes in a user's home for a limited period. Selectable icons permit users to select images for purchase in electronic form or in hard-copy form.

### BACKGROUND

1. Field of the Disclosure

The present disclosure generally relates to distribution of multimedia content, and particularly, to managing the distribution of visual art through a digital television network.

2. Description of the Related Art

Artwork is often displayed in brick-and-mortar galleries. In such cases, exposure to the work of art is limited to individuals that visit the gallery. To view a work of art such as a painting outside the gallery, an individual may be required to purchase the painting.

### BRIEF DESCRIPTION OF THE DRAWINGS

FIG. 1 depicts a multimedia content distribution network enabled for distribution of digital television content and, in accordance with disclosed embodiments, for managing the distribution of visual art;

FIG. 2 depicts selected elements of an example architecture for managing the distribution of visual art through a digital television network in accordance with disclosed embodiments;

FIG. 3 depicts selected operations for managing the distribution of visual art through a digital television network in accordance with disclosed embodiments; and

FIG. 4 depicts a data processing system that may be used in accordance with disclosed embodiments for managing the distribution of visual art.

### DESCRIPTION OF THE EMBODIMENT(S)

In one aspect, an image hosting service is disclosed that includes providing, through a digital television distribution network, a plurality of selectable identifiers for a user to choose a portion of a plurality of stored images. The plurality of stored images represents works of visual art. The stored images may include still images, and the image hosting service may further include streaming video feed of works of visual art from a first location (of the work of visual art) to a second location (of a user). The image hosting service also includes providing access to the portion of the plurality of stored images through the digital television distribution network. In some embodiments, providing access to the portion of the plurality of stored images includes distributing the portion of the plurality of stored images to a plurality of set-top boxes at the user location. In some embodiments, the image hosting service further includes downloading, to a set-top box, copies of the plurality of stored images. The image hosting service may also include preventing access to the portion of the plurality of stored images after expiration of a limited period. In some embodiments, the image hosting service includes an interface for the user to purchase for physical delivery to the user a hard copy of one or more of the portion of the plurality of stored images.

In another aspect, a method is disclosed for providing access to visual art through a digital television distribution network. The method includes enabling a user of the digital television distribution network to select a work of visual art for display. The method further includes providing the user access for a limited period to a stored electronic version of the selected work of visual art, in which the electronic version is used for displaying a depiction of the work of visual art on a display. In some embodiments, the method includes providing an advertisement with the displayed depiction of the work of visual art. The method may further include charging a fee to the user for access to the electronic version of the selected work of visual art through a user account associated with the digital television distribution network. Some embodiments of the method include automatically presenting the user with choices for selectable works of visual art, wherein the choices for selectable works of visual art are based on an estimated taste of the user derived at least in part from comparing previous selections of the user with similar selections of other users. The method may further include randomizing an order in which depictions of works of visual art are accessed by a set-top box associated with the user.

In still another aspect, an embodied set-top box is enabled by instructions stored on a computer readable media. The computer readable instructions enable the set-top box to present an electronic guide that includes a plurality of identifiers that correspond to a plurality of works of visual art that are available for access over a digital television network. Further instructions are for receiving a user command to select one or more of the plurality of identifiers. Still further instructions are for accessing electronic data corresponding to the plurality of works of visual art for the selected plurality of identifiers and providing video signals to a display unit for displaying depictions of a portion of plurality of works of visual art.

Disclosed embodiments relate to the storing, publishing, and displaying visual art (e.g. images, audio, video, games) via digital television networks (e.g., Internet Protocol Television (IPTV) networks). In some embodiments, the uploading, cataloging, publishing, and displaying of art is related to a subscription-based online art gallery. Accordingly, local, national, or international artists may upload, store, and distribute their art.

An exemplary embodiment includes a secure web based tool (e.g., a file transfer protocol (ftp) server) for an artist or art galleries to upload and store images of their art (photographs of artwork, paintings, etc). As necessary, provisions are made for rights management and optional payment methods for such services. Such payment methods may include a billing interface provisioned by a backend billing system (operations-systems-support/business-systems-support (OSS/BSS) applications) for a multimedia content distribution network.

In an example scenario, a user who plans to have a cocktail party, for example, may seek to have local art displayed throughout the user's house during the cocktail party. Using disclosed embodiments, the user may select a local gallery or artist through a graphical user interface presented on a personal computer, a smart phone, personal digital assistant, or television. In some cases, the user may select and choreograph the display of multiple images among several displays in the user's house. In addition, optional soundtracks may accompany the display of the artwork.

Disclosed systems may allow relatively unknown artists to build a wider base for distributing their work. With the advent of high definition televisions, artwork may be reproduced in high quality for display on consumer televisions. Therefore, disclosed systems allow a piece of art to be on display in two or more places at once, which may increase revenue for artists. Disclosed systems also permit users to enjoy expensive artwork without having to purchase it at full price.

Disclosed systems permit an artist to display, rent, or sell their art via IPTV. Such systems bring artists and consumers or potential customers closer and provide both a mechanism for marketing, advertising, and distribution. Disclosed systems may include “click to buy” options through remote control devices. In this way, customers may order original artwork or prints of the original artwork.

Some disclosed embodiments permit tagging or selecting of identifiers for works of visual art that are presented as part of an electronic programming guide (EPG) associated with a digital television distribution network, for example. Tagging on-demand selections may be through pressing a “select” button on a remote control device, for example. In some cases, a user may press the “select” button while a depiction of a work of art is presented on a display. Some disclosed embodiments permit users to search and select visual work identifiers remotely (e.g., via web access or a cellular telephone). In some embodiments, predictive analysis may be performed to offer works of visual art to a user based on what other users have selected that are estimated to have similar tastes, for example. A user may set up a gallery of selected works of visual art that are played along with background music.

In the following description, details are set forth by way of example to enable one of ordinary skill in the art to practice the claimed subject matter without undue experimentation. It should be apparent to a person of ordinary skill that disclosed embodiments are examples and not exhaustive of all possible embodiments. Regarding reference numerals used to describe elements in the figures, a hyphenated form of a reference numeral refers to a specific instance of an element and the un-hyphenated form of the reference numeral refers to the element generically or collectively. Thus, for example, element “121-1” refers to an instance of an STB, which may be referred to collectively as STBs “121” and any one of which may be referred to generically as an STB “121.”

Before describing other details of embodied methods and devices, selected aspects of service provider networks that provide multimedia programs are described to provide further context.

Television programs, video on-demand (VOD) movies, digital television content, music programming, and a variety of other types of multimedia content may be distributed to multiple users (e.g., subscribers) over various types of networks. Suitable types of networks that may be configured to support the provisioning of multimedia content services by a service provider include, as examples, telephony-based networks, coaxial-based networks, satellite-based networks, and the like.

In some networks including, for example, traditional coaxial-based “cable” networks, whether analog or digital, a service provider distributes a mixed signal that includes a relatively large number of multimedia content channels (also referred to herein as “channels”), each occupying a different frequency band or channel, through a coaxial cable, a fiber-optic cable, or a combination of the two. The bandwidth required to transport simultaneously large numbers of multimedia channels may challenge cable-based providers. In these types of networks, a tuner within a set-top box (STB), television, or other form of receiver is required to select a channel from the mixed signal for playing or recording. A user wishing to play or record multiple channels typically needs to have distinct tuners for each desired channel. This is an inherent limitation of cable networks and other mixed signal networks.

In contrast to mixed signal networks, IPTV networks generally distribute content to a user only in response to a user request so that, at any given time, the number of content channels being provided to a user is relatively small, e.g., one channel for each operating television plus possibly one or two channels for simultaneous recording. As suggested by the name, IPTV networks typically employ IP and other open, mature, and pervasive networking technologies. Instead of being associated with a particular frequency band, an IPTV television program, movie, or other form of multimedia content is a packet-based stream that corresponds to a particular network address, e.g., an IP address. In these networks, the concept of a channel is inherently distinct from the frequency channels native to mixed signal networks. Moreover, whereas a mixed signal network requires a hardware intensive tuner for every channel to be played, IPTV channels can be “tuned” simply by transmitting to a server an IP or analogous type of network address that is associated with the desired channel.

IPTV may be implemented, at least in part, over existing infrastructure including, for example, a proprietary network that may include existing telephone lines, possibly in combination with customer premise equipment (CPE) including, for example, a digital subscriber line (DSL) modem in communication with a STB, a display, and other appropriate equipment to receive multimedia content from a provider network and convert such content into usable form. In some implementations, a core portion of an IPTV network is implemented with fiber optic cables while the so-called “last mile” may include conventional, unshielded, twisted-pair, copper cables.

IPTV networks support bidirectional (i.e., two-way) communication between a subscriber's CPE and a service provider's equipment. Bidirectional communication allows a service provider to deploy advanced features, such as VOD, pay-per-view, advanced programming information (e.g., sophisticated and customizable EPGs), and the like. Bidirectional networks may also enable a service provider to collect information related to a user's preferences, whether for purposes of providing preference based features to the user, providing potentially valuable information to service providers, or providing potentially lucrative information to content providers and others.

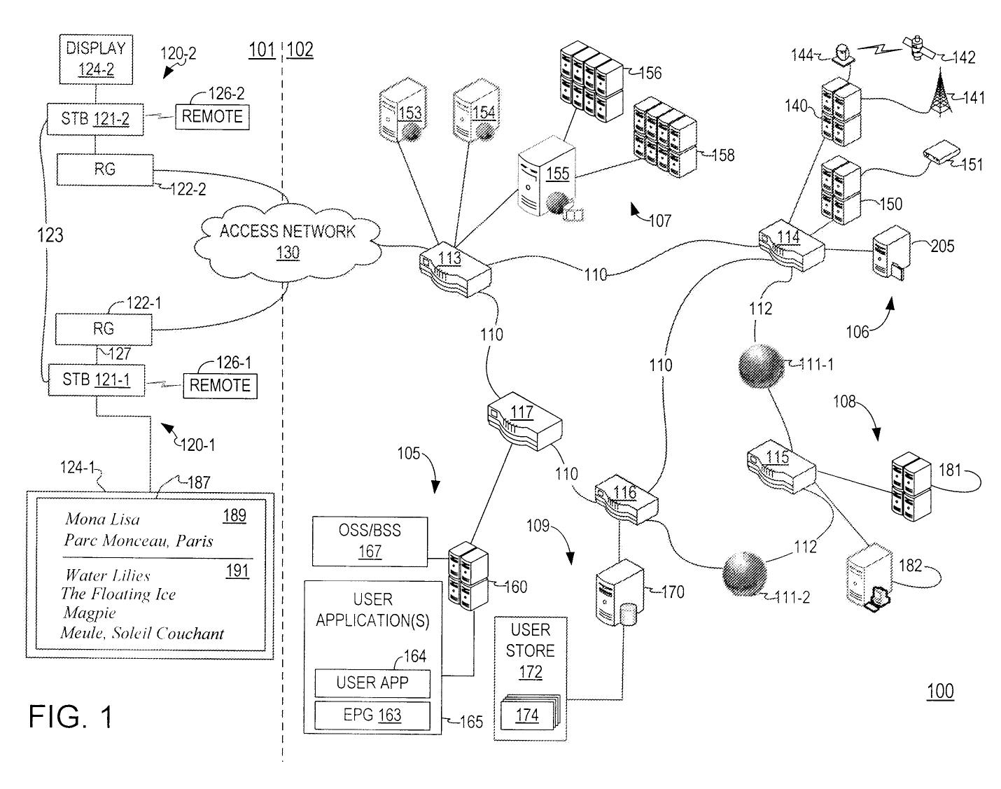

Referring now to the drawings, FIG. 1 illustrates selected aspects of a multimedia content distribution network (MCDN) 100 for managing the distribution of visual art in accordance with disclosed embodiments. MCDN 100, as shown, is a digital television network (i.e., a provider network) that may be generally divided into a client side 101 and a service provider side 102 (a.k.a. server side 102). The client side 101 includes all or most of the resources depicted to the left of access network 130 while the server side 102 encompasses the remainder.

Client side 101 and server side 102 are linked by access network 130. In embodiments of MCDN 100 that leverage telephony hardware and infrastructure, access network 130 may include the “local loop” or “last mile,” which refers to the physical wires that connect a subscriber's home or business to a local exchange. In these embodiments, the physical layer of access network 130 may include twisted pair copper cables or fiber optics cables employed as either fiber to the curb (FTTC) or fiber to the home (FTTH).

Access network 130 may include hardware and firmware to perform signal translation when access network 130 includes multiple types of physical media. For example, an access network that includes twisted-pair telephone lines to deliver multimedia content to consumers may utilize DSL. In embodiments of access network 130 that implement FTTC, a DSL access multiplexer (DSLAM) may be used within access network 130 to transfer signals containing multimedia content from optical fiber to copper wire for DSL delivery to consumers.

In other embodiments, access network 130 may transmit radio frequency (RF) signals over coaxial cables. In these embodiments, access network 130 may utilize quadrature amplitude modulation (QAM) equipment for downstream traffic. In these embodiments, access network 130 may receive upstream traffic from a consumer's location using quadrature phase shift keying (QPSK) modulated RF signals. In such embodiments, a cable modem termination system (CMTS) may be used to mediate between IP-based traffic on private network 110 and access network 130.

Services provided by the server side resources as shown in FIG. 1 may be distributed over a private network 110. In some embodiments, private network 110 is referred to as a “core network.” In at least some embodiments, private network 110 includes a fiber optic wide area network (WAN), referred to herein as the fiber backbone, and one or more video hub offices (VHOs). In large-scale implementations of MCDN 100, which may cover a geographic region comparable, for example, to the region served by telephony-based broadband services, private network 110 includes a hierarchy of VHOs.

A national VHO, for example, may deliver national content feeds to several regional VHOs, each of which may include its own acquisition resources to acquire local content, such as the local affiliate of a national network, and to inject local content such as advertising and public service announcements from local entities. The regional VHOs may then deliver the local and national content for reception by subscribers served by the regional VHO. The hierarchical arrangement of VHOs, in addition to facilitating localized or regionalized content provisioning, may conserve bandwidth by limiting the content that is transmitted over the core network and injecting regional content “downstream” from the core network.

Segments of private network 110, as shown in FIG. 1, are connected together with a plurality of network switching and routing devices referred to simply as switches 113 through 117. The depicted switches include client facing switch 113, acquisition switch 114, operations-systems-support/business-systems-support (OSS/BSS) switch 115, database switch 116, and an application switch 117. In addition to providing routing/switching functionality, switches 113 through 117 preferably include hardware or firmware firewalls, not depicted, that maintain the security and privacy of network 110. Other portions of MCDN 100 communicate over a public network 112, including, for example, the Internet or other type of web-network where the public network 112 is signified in FIG. 1 by the World Wide Web icons 111.

As shown in FIG. 1, the client side 101 of MCDN 100 depicts two of a potentially large number of client side resources referred to herein simply as client(s) 120. Each client 120, as shown, includes an STB 121, a residential gateway (RG) 122, a display 124, and a remote control device 126. In the depicted embodiment, STB 121 communicates with server side devices through access network 130 via RG 122.

In accordance with disclosed embodiments, STB 121 may be enabled by instructions stored on a computer readable media for managing the distribution of visual art (i.e., managing the distribution of depictions of visual art). Such executed computer instructions enable STB 121 for presenting an electronic guide (e.g., user interface 187) that includes a plurality of identifiers (e.g., identifiers 191) that correspond to a plurality of works of visual art (not depicted in FIG. 1) that are available for access over a digital television network (e.g., MCDN 100). Using selectable icons or other input, embodied STBs may further be enabled by computer instructions for receiving user commands to select one or more of a plurality of identifiers that correspond to works of visual art. In response, an embodied STB may access electronic data corresponding to the plurality of works of visual art for the selected plurality of identifiers. For example, embodied STBs may download electronic files that contain electronic versions of works of visual art. Embodied STBs then provide video signals to a display unit (e.g., a television) for displaying depictions of a portion of plurality of works of visual art. In operation, depictions of the works of visual art are formed and displayed from electronic versions created from a visual work of art. For example, electronic versions of a work of visual art may be created by scanning, photographing, filming, or other processes. Some embodied STBs are enabled by computer instructions for coordinating the display of multiple depictions of works of visual art with further set-top boxes at a user location. In addition, embodied STBs may be enabled to present a plurality of music identifiers that correspond to a plurality of music works to allow a user to select music that accompanies the display of depictions of works of visual art. Accordingly, embodied STBs may be enabled by computer instructions for managing the distribution and display of works of visual art.

As shown in FIG. 1, RG 122 may include elements of a broadband modem such as a DSL modem, as well as elements of a router and/or access point for an Ethernet or other suitable local area network (LAN) 123. In this embodiment, STB 121 is a uniquely addressable Ethernet compliant device. In some embodiments, display 124 may be any National Television System Committee (NTSC) and/or Phase Alternating Line (PAL) compliant display device. Both STB 121 and display 124 may include any form of conventional frequency tuner. Remote control device 126 communicates wirelessly with STB 121 using an infrared (IR) or RF signal. STB 121-1 and STB 121-2, as shown, may communicate through LAN 123 in accordance with disclosed embodiments to display visual art.

In IPTV compliant implementations of MCDN 100, the clients 120 are operable to receive packet-based multimedia streams from access network 130 and process the streams for presentation on displays 124. In addition, clients 120 are network-aware systems that may facilitate bidirectional-networked communications with server side 102 resources to facilitate network hosted services and features. Because clients 120 are operable to process multimedia content streams while simultaneously supporting more traditional web-like communications, clients 120 may support or comply with a variety of different types of network protocols including streaming protocols such as reliable datagram protocol (RDP) over user datagram protocol/internet protocol (UDP/IP) as well as web protocols such as hypertext transport protocol (HTTP) over transport control protocol (TCP/IP).

The server side 102 of MCDN 100 as depicted in FIG. 1 emphasizes network capabilities including application resources 105, which may have access to database resources 109, content acquisition resources 106, content delivery resources 107, and OSS/BSS resources 108.

Before distributing multimedia content to users, MCDN 100 first obtains multimedia content (e.g., digital television programs) from content providers. To that end, acquisition resources 106 encompass various systems and devices to acquire multimedia content, reformat it when necessary, and process it for delivery to subscribers over private network 110 and access network 130.

Acquisition resources 106 may include, for example, systems for capturing analog and/or digital content feeds, either directly from a content provider or from a content aggregation facility. Content feeds transmitted via VHF/UHF broadcast signals may be captured by an antenna 141 and delivered to live acquisition server 140. Similarly, live acquisition server 140 may capture downlinked signals transmitted by a satellite 142 and received by a parabolic dish 144. In addition, live acquisition server 140 may acquire programming feeds transmitted via high-speed fiber feeds or other suitable transmission means. Acquisition resources 106 may further include signal conditioning systems and content preparation systems for encoding content.

As depicted in FIG. 1, content acquisition resources 106 include a VOD acquisition server 150. VOD acquisition server 150 receives content from one or more VOD sources that may be external to the MCDN 100 including, as examples, discs represented by a DVD player 151, or transmitted feeds (not shown). VOD acquisition server 150 may temporarily store multimedia content for transmission to a VOD delivery server 158 in communication with client-facing switch 113. Visual art server 205, as shown, is enabled for introducing, in accordance with some disclosed embodiments, works of visual art to MCDN 100. Specifically, electronic data corresponding to a plurality of works of visual art is introduced to MCDN 100 for formatting and transfer to STBs 121 for presentation on displays 124.

After acquiring multimedia content, acquisition resources 106 may transmit acquired content over private network 110, for example, to one or more servers in content delivery resources 107. Prior to transmission, live acquisition server 140 may encode acquired content using, e.g., MPEG-2, H.263, a Windows Media Video (WMV) family codec, or another suitable video codec. Acquired content may be encoded and composed to preserve network bandwidth and network storage resources and, optionally, to provide encryption for securing the content. VOD content acquired by VOD acquisition server 150 may be in a compressed format prior to acquisition and further compression or formatting prior to transmission may be unnecessary and/or optional.

Content delivery resources 107 as shown in FIG. 1 are in communication with private network 110 via client facing switch 113. In the depicted implementation, content delivery resources 107 include a content delivery server 155 in communication with a live or real-time content server 156 and a VOD delivery server 158. For purposes of this disclosure, the use of the term “live” or “real-time” in connection with content server 156 is intended primarily to distinguish the applicable content from the content provided by VOD delivery server 158. The content provided by a VOD server is sometimes referred to as time-shifted content to emphasize the ability to obtain and view VOD content substantially without regard to the time of day or the day of week.

Content delivery server 155, in conjunction with live content server 156 and VOD delivery server 158, responds to user requests for content by providing the requested content to the user. The content delivery resources 107 are, in some embodiments, responsible for creating video streams that are suitable for transmission over private network 110 and/or access network 130. In some embodiments, creating video streams from the stored content generally includes generating data packets by encapsulating relatively small segments of the stored content in one or more packet headers according to the network communication protocol stack in use. These data packets are then transmitted across a network to a receiver (e.g., STB 121 of client 120), where the content is parsed from individual packets and re-assembled into multimedia content suitable for processing by an STB decoder.

User requests received by content delivery server 155 may include an indication of the content that is being requested. In some embodiments, this indication includes an IP address associated with the desired content. For example, a particular local broadcast television station may be associated with a particular channel and the feed for that channel may be associated with a particular IP address. Alternatively, in accordance with some disclosed embodiments, a particular art gallery may be associated with a particular channel and the feed for that channel may be associated with a particular IP address. When a subscriber wishes to view the station or art gallery, the subscriber may interact with remote control device 126 to send a signal to STB 121 indicating a request for the particular channel. When STB 121 responds to the remote control signal, the STB 121 changes to the requested channel by transmitting a request that includes an IP address associated with the desired channel to content delivery server 155.

Content delivery server 155 may respond to a request by making a streaming video signal accessible to the user. In accordance with disclosed embodiments, the streaming video signal may be live feed or substantially live feed captured from sculptures, oil paintings, landscapes, or other works of visual art. Content delivery server 155 may employ unicast and broadcast techniques when making content available to a user. In the case of multicast, content delivery server 155 employs a multicast protocol to deliver a single originating stream to multiple clients. When a new user requests the content associated with a multicast stream, there may be latency associated with updating the multicast information to reflect the new user as a part of the multicast group. To avoid exposing this undesirable latency to the subscriber, content delivery server 155 may temporarily unicast a stream to the requesting subscriber. When the subscriber is ultimately enrolled in the multicast group, the unicast stream is terminated and the subscriber receives the multicast stream. Multicasting desirably reduces bandwidth consumption by reducing the number of streams that must be transmitted over the access network 130 to clients 120.

As illustrated in FIG. 1, a client-facing switch 113 provides a conduit between client side 101, including client 120, and server side 102. Client-facing switch 113, as shown, is so-named because it connects directly to the client 120 via access network 130 and it provides the network connectivity of IPTV services to users' locations. To deliver multimedia content, client-facing switch 113 may employ any of various existing or future Internet protocols for providing reliable real-time streaming multimedia content. In addition to the TCP, UDP, and HTTP protocols referenced above, such protocols may use, in various combinations, other protocols including, real-time transport protocol (RTP), real-time control protocol (RTCP), file transfer protocol (FTP), and real-time streaming protocol (RTSP), as examples.

In some embodiments, client-facing switch 113 routes multimedia content encapsulated into IP packets over access network 130. For example, an MPEG-2 transport stream may be sent, in which the transport stream consists of a series of 188-byte transport packets. Client-facing switch 113 as shown is coupled to a content delivery server 155, acquisition switch 114, applications switch 117, a client gateway 153, and a terminal server 154 that is operable to provide terminal devices with a connection point to the private network 110. Client gateway 153 may provide subscriber access to private network 110 and the resources coupled thereto.

In some embodiments, STB 121 may access MCDN 100 using information received from client gateway 153. Subscriber devices may access client gateway 153 and client gateway 153 may then allow such devices to access the private network 110 once the devices are authenticated or verified. Similarly, client gateway 153 may prevent unauthorized devices, such as hacker computers or stolen STBs, from accessing the private network 110. Accordingly, in some embodiments, when an STB 121 accesses MCDN 100, client gateway 153 verifies subscriber information by communicating with user store 172 via the private network 110. Client gateway 153 may verify billing information and subscriber status by communicating with an OSS/BSS gateway 167. OSS/BSS gateway 167 may transmit a query to the OSS/BSS server 181 via an OSS/BSS switch 115 that may be connected to a public network 112. Upon client gateway 153 confirming subscriber and/or billing information, client gateway 153 may allow STB 121 access to IPTV content, VOD content, and other services. If client gateway 153 cannot verify subscriber information (i.e., user information) for STB 121, for example, because it is connected to an unauthorized twisted pair or RG, client gateway 153 may block transmissions to and from STB 121 beyond the private access network 130.

MCDN 100, as depicted, includes application resources 105, which communicate with private network 110 via application switch 117. Application resources 105 as shown include an application server 160 operable to host or otherwise facilitate one or more user applications 165 that may be made available to system subscribers. For example, user applications 165 as shown include an EPG application 163. User applications 165 may include other applications as well. In addition to user applications 165, application server 160 may host or provide a gateway to operation support systems and/or business support systems. In some embodiments, communication between application server 160 and the applications that it hosts and/or communication between application server 160 and client 120 may be via a conventional web based protocol stack such as HTTP over TCP/IP or HTTP over UDP/IP.

Application server 160 as shown also hosts an application referred to generically as user application 164. User application 164 represents an application that may deliver a value added feature to a user, who may be a subscriber to a service provided by MCDN 100. User application 164 is illustrated in FIG. 1 to emphasize the ability to extend the network's capabilities by implementing a network-hosted application. Because the application resides on the network, it generally does not impose any significant requirements or imply any substantial modifications to the client 120 including the STB 121. In some instances, an STB 121 may require knowledge of a network address associated with user application 164, but STB 121 and the other components of client 120 are largely unaffected.

As shown in FIG. 1, a database switch 116 connected to applications switch 117 provides access to database resources 109. Database resources 109 include a database server 170 that manages a system storage resource 172, also referred to herein as user store 172. User store 172, as shown, includes one or more user profiles 174 where each user profile includes account information and may include preferences information that may be retrieved by applications executing on application server 160 including user applications 165.

MCDN 100, as shown, includes an OSS/BSS resource 108 including an OSS/BSS switch 115. OSS/BSS switch 115 facilitates communication between OSS/BSS resources 108 via public network 112. The OSS/BSS switch 115 is coupled to an OSS/BSS server 181 that hosts operations support services including remote management via a management server 182. OSS/BSS resources 108 may include a monitor server (not depicted) that monitors network devices within or coupled to MCDN 100 via, for example, a simple network management protocol (SNMP).

As shown in FIG. 1, MCDN 100 may be used to provide network-based management of visual art in accordance with disclosed embodiments. In this way, MCDN 100 supports an image hosting service. In operation, the image hosting service includes providing a plurality of selectable identifiers for choosing a portion of a plurality of stored images. The plurality of stored images represents works of visual art. The stored images may be created by live camera, digitized through scanning, or otherwise converted into electronic format. In some embodiments, works of art or photographs originate in electronic format and may require no further processing. Embodied image hosting services may also include providing access to the portion of the plurality of stored images through a digital television network such as MCDN 100. Electronic versions of works of art may be hosted by a network server (e.g., visual art server 205) or downloaded to a set-top box (e.g., STB 121-2). In addition, copies of multiple images may be stored in separate locations for backing up the images or distributing the images. If images are downloaded to an STB, for example, embodied image hosting services may prevent access to some images after expiration of a limited period. To assist an artist or network provider with marketing works of visual art, embodied image hosting services may provide an interface for a user to purchase for physical delivery to the user a hard copy of one or more stored images.

If an embodied image hosting service distributes stored images to one or more STBs at a user location, the image hosting service may signal the STB to disable a recording feature in the STB or an associated digital video recorder (DVR). Some embodied image hosting services may provide streaming video through a digital television distribution network of a work of visual art located in a first location (e.g., a museum in Europe) to a second location (e.g., a home in North America).

Referring to FIG. 1, user selectable identifiers 191 that correspond to works of visual art may be presented on display 124 graphical user interface 187. The user selectable identifiers 191 may be icons or selectable text, as examples, that allow a user to select a work of visual art for immediate consumption (e.g., viewing) or for addition to a gallery (e.g., gallery 189) in accordance with disclosed embodiments. The user selectable identifiers 191 correspond to the works of visual art including oil paintings, sculptures, photographs, and computer-created works, as examples. In some embodiments, selectable identifiers (e.g., identifiers 191) that correspond to works of visual art may be presented in email advertisements, in web banners, in a list of identifiers on a digital television EPG, or may be presented in other suitable ways. Using graphical interface 187, a user may customize the order in which depictions of visual art are displayed. For example, a user may “click and drag” identifiers in gallery 189 to change the order in which depictions of works of visual art are displayed. In addition, disclosed systems may randomize the order in which depictions of works of visual art are displayed. Special effects for transitioning between depictions may be available with disclosed embodiments (e.g., fading in and out.

MCDN 100 may also be used for providing a means of adding the identifiers to the user's gallery. For example, a user may move a pointer on display 124 using a mouse, voice commands, a joystick, biometric sensors, eye movement sensors, a remote control with directional arrows, a touch screen, or similar input means for adding identifiers to a user's gallery. As shown in FIG. 1, display 124-1 presents graphical user interface 187 that includes identifiers 191 that correspond to works of visual art (e.g., oil paintings, sculptures) that may be added to user gallery 189. As shown, STB 121-2 and STB 121-1 are communicatively coupled through LAN 123. Although only two STBs are shown in FIG. 1, more or less STBs may be enabled and linked in accordance with disclosed embodiments to allow a user to display depictions of works of visual art in a number of rooms. In some embodiments, STB 121-1 communicates with STB 121-2 to coordinate the display of visual art throughout different rooms of a home, for example.

In response to user input to view a gallery, embodied digital television services provided by MCDN 100 may present the gallery on display 124. STB 121 may include computer program instructions stored on a computer readable media and enabled for presenting the selectable identifiers of visual art as part of an EPG, for example, on display 124. If any depiction of a work of visual art in a user's gallery is not yet available for viewing, STB 121 or a network-based server within MCDN 100 may be enabled for automatically sending the user a reminder regarding when the depiction of the work of visual art is available. If the depiction of the work of visual art in the gallery is available only for limited time, a user may be presented by disclosed embodiments with one or more indicators conveying to the user how much time is available for viewing the depiction of the work of visual art. For example, if a depiction of the work of visual art in the user's gallery is only available for two more months, MCDN 100 may present to the user on display 124 a date (i.e., a text-based indicator) to tell the user how much time the user has to view the depiction of the work of visual art. Alternatively, a graphical icon on display 124 or both may be presented to the user to indicate the time remaining for viewing the depiction of the work of visual art. The graphical icon may change colors or may appear with varied transparency to indicate how much time is left to view the multimedia program.

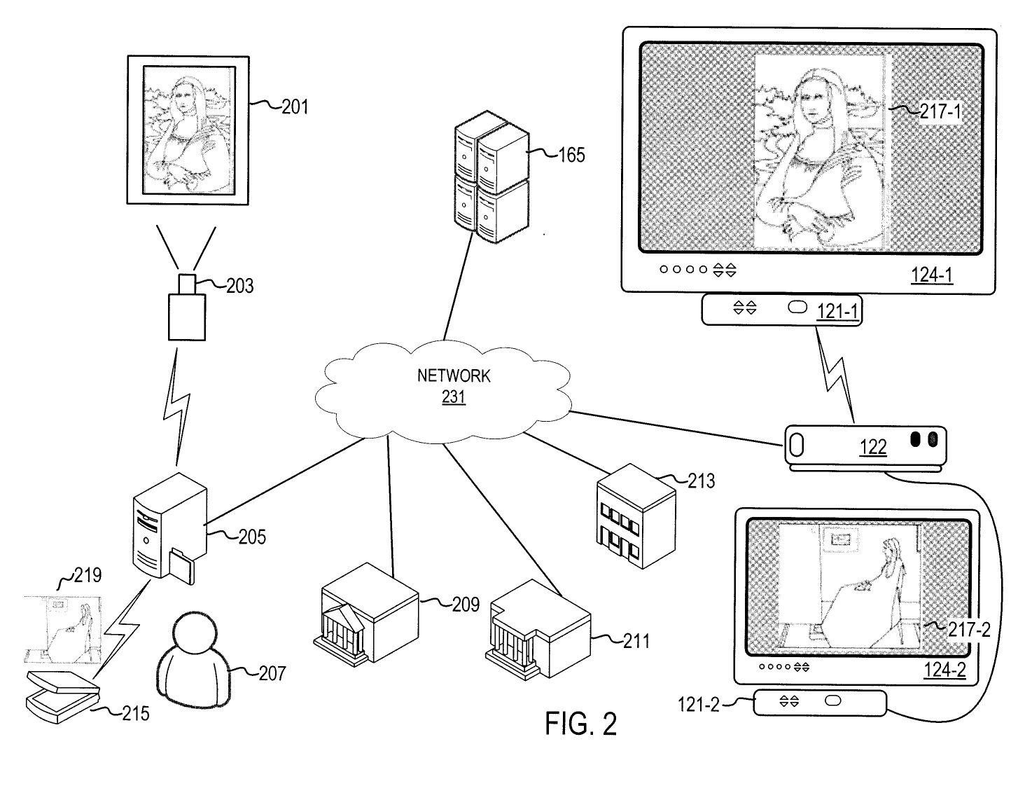

FIG. 2 depicts selected elements of an example architecture for managing the distribution of visual art through a digital television network in accordance with disclosed embodiments. As shown, art gallery 209 may contain artwork that users of embodied systems wish to view. For example, art gallery 209 may be a brick-and-mortar building with hundreds of oil paintings and sculptures. To increase exposure to the visual works of art within art gallery 209, images of the works of art within may be stored or streamed over network 231 to RG 122 that is in communication, as shown, with STBs 121 for presentation on displays 124. Similarly, works of art created or housed at university 211 or art studio 213 may be provided over network 231 for display. This allows professional artists associated with artist studio 213 with increased exposure to the artists' works. In addition, works of art associated with university 211 have increased exposure.

Application server 165 may receive requests from RG 122 or STBs 121 over network 231 to send electronic versions of works of visual art. Before the electronic version of works of visual art can be sent, the electronic versions have to be created. To this end, the system embodied in FIG. 2 uses camera 203 for capturing streaming video or still images from first work of visual art 201, which is an oil painting. Similarly, still images from second work of visual art 219 are captured by scanner 215 and converted to electronic format for storing on server 205 or application server 165. As shown, scanner 215 is operated by artist 207 who created or purchased rights to second work of visual art 219. Artist 207 may also be a rights management authority that is paid based on the number of times the second work of visual art 219 is accessed, requested, or displayed. As shown, second work of visual art 219 corresponds to second visual art still image 212-2, which is a depiction of second visual art still image 212-2 created from electronic files or data. Similarly, first visual art still image 217-1 is a depiction of first work of visual art 201. Network 231 may be a proprietary network, the Internet, or a combination of such networks.

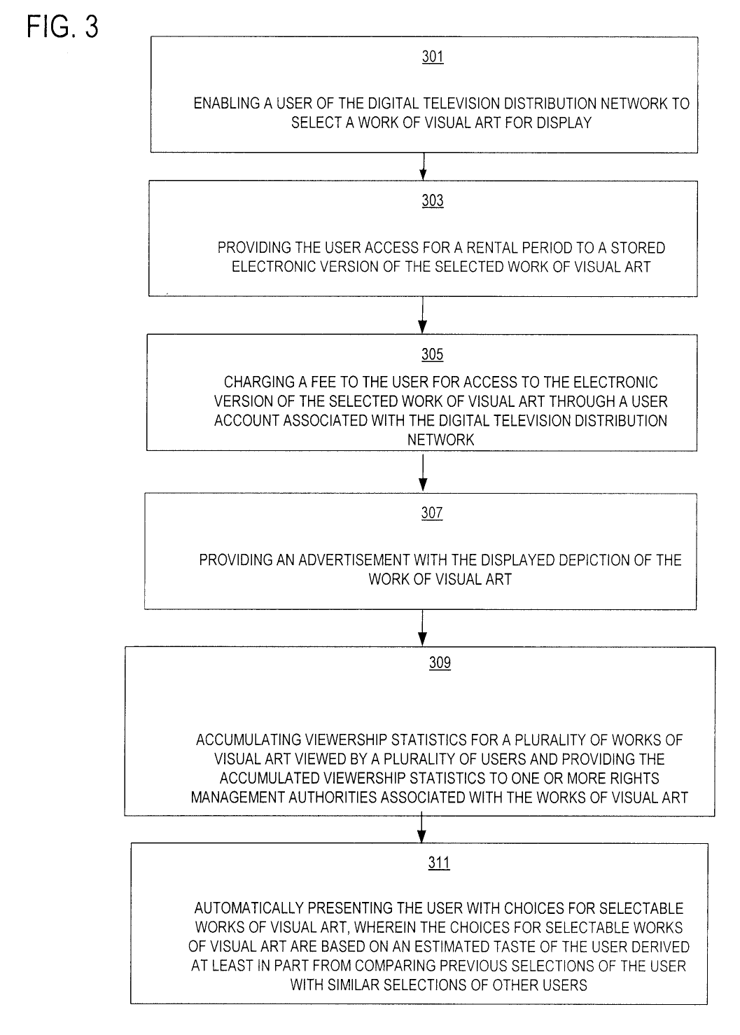

FIG. 3 illustrates selected operations for managing and distributing works of visual art in accordance with disclosed embodiments. As shown, operation 301 relates to enabling a user of a digital television distribution network to select a work of visual art for display. For example, a user may select an identifier (e.g., icon) from a list presented on an EPG. The identifier may be the name of the work of art, a thumbnail view of the work of art, or some other representation of the work of art to allow the user to identify and select it. In some embodiments, a user may select a plurality of works of art to create a virtual gallery. Operation 303 relates to providing the user access for a limited period to a stored electronic version of the selected work of visual art. In some embodiments, the stored electronic version is used for displaying a depiction of the work of visual art on a display that is fed by an STB. The limited period may be an hour, a day, a year, or another period suitable to the user. As shown in FIG. 3, operation 305 relates to charging a fee to the user for access to the electronic version of the selected work of visual art through a user account associated with the digital television distribution network. Optional operation 307 relates to providing an advertisement with the displayed depiction of the work of visual art. For example, advertisements for other multimedia content, unrelated products, music, or the like may be presented as part of the displayed depiction of the work of visual art. In addition or alternatively, embodied systems may provide for users to purchase hard copies to be sent to the user. For example, a user may click a “buy it now” icon presented with the display to permit the user to receive a printed version of a photograph or oil painting, as examples. Alternatively, the user may receive an electronic version of the work of visual art that can be displayed in accordance with a license worked out between the service provider and the user. Some embodiments include providing a billing interface provisioned by a backend billing system for a digital television distribution network. Such systems would allow a subscriber of digital television content the convenience of receiving a single bill for both purchased artwork and digital television service.

As shown in FIG. 3, operation 309 relates to accumulating viewership statistics for a plurality of works of visual art viewed by a plurality of users and providing the accumulated viewership statistics to one or more rights management authorities associated with the works of visual art. Operation 309 therefore may, in some embodiments, help a rights management authority such as a copyright holder or licensing agency to pay an artist a fee related to the number of times the artist's works are rented or viewed.

Embodied systems and methods may provide users with automatic features to enhance the user experience when viewing depictions of works of visual art. For example, operation 311 relates to automatically presenting the user with choices for selectable works of visual art. In some embodiments, the choices for selectable works of visual art are based on an estimated taste of the user derived from comparing previous selections of the user with similar selections of other users. Once selections are added to a user's gallery or otherwise selected for viewing, embodied systems may randomize the order in which depictions of works of visual art are displayed. Embodied systems may automatically play music or other sounds to accompany displays of visual art (i.e., displays of depictions of visual art). Accordingly, users may be provided with a plurality of music selections that are selected to accompany the display of depictions of works of visual art.

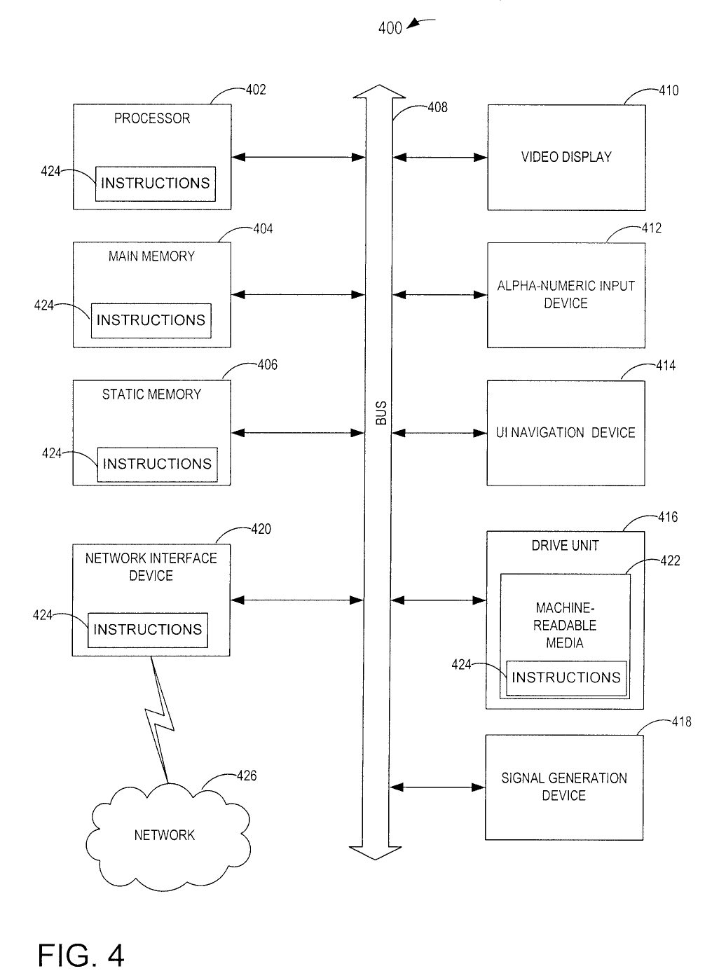

FIG. 4 illustrates in block diagram form a data processing system 400 within which a set of instructions may operate to perform one or more of the methodologies discussed herein. Data processing system 400 may operate as a standalone device or may be connected (e.g., networked) to other data processing systems. In a networked deployment, data processing system 400 may operate in the capacity of a server or a client data processing system in a server-client network environment, or as a peer computer in a peer-to-peer (or distributed) network environment. Example data processing systems include, but are not limited to a DVR, a personal computer (PC), a tablet PC, STB, a cable box, a satellite box, an EPG box, a personal data assistant, a cellular telephone, a smart phone, a web appliance, a network router, a switch, a bridge, a server, or any machine capable of executing a set of instructions (sequential or otherwise) that specify actions to be taken by that machine. Further, while only a single data processing system is illustrated, the term “data processing system” shall also be taken to include any collection of data processing systems that individually or jointly execute a set (or multiple sets) of instructions to perform any one or more of the methodologies discussed herein.

As shown, data processing system 400 includes a processor 402 (e.g., a central processing unit, a graphics processing unit, or both), a main memory 404, and a static memory 406 that may communicate with each other via a bus 408. In some embodiments, the main memory 404 and/or the static memory 406 may be used to store the indicators or values that relate to multimedia content accessed or requested by a consumer. Data processing system 400 may further include a video display unit 410 (e.g., a television, a liquid crystal display or a cathode ray tube) on which to display multimedia content such as pay-per-view sporting events, television programs, VOD movies, and the like. Data processing system 400 also includes an alphanumeric input device 412 (e.g., a keyboard or a remote control), a user interface (UT) navigation device 414 (e.g., a remote control or a mouse), a disk drive unit 416, a signal generation device 418 (e.g., a speaker) and a network interface device 420. The input device 412 and/or the UT navigation device 414 (e.g., the remote control) may include a processor (not shown), and a memory (not shown). The disk drive unit 416 includes a machine-readable medium 422 that may have stored thereon one or more sets of instructions and data structures (e.g., instructions 424) embodying or utilized by any one or more of the methodologies or functions described herein. The instructions 424 may also reside, completely or at least partially, within the main memory 404, within static memory 406, within network interface device 420, and/or within the processor 402 during execution thereof by the data processing system 400.

The instructions 424 may further be transmitted or received over a network 426 (e.g., a content provider) via the network interface device 420 utilizing any one of a number of transfer protocols (e.g., broadcast transmissions, HTTP). While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine (i.e., data processing system) and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

While the disclosed systems may be described in connection with one or more embodiments, it is not intended to limit the subject matter of the claims to the particular forms set forth. On the contrary, disclosed systems are intended to include alternatives, modifications and equivalents as may be included within the spirit and scope of the subject matter as defined by the appended claims. For example, the term “set-top box” or “STB” may be used to describe functionality that may be integrated into a television, residential gateway, or other receiver.

What is claimed is:

1. An image hosting service comprising:
providing, through a digital television distribution network, a plurality of selectable identifiers for a plurality of stored images, wherein the stored images are generated from works of visual art; and
providing, through the digital television distribution network, access to a portion of the plurality of stored images for a limited period in response to a user selecting a portion of the plurality of selectable identifiers.

2. The image hosting service of claim 1, further comprising:
downloading, to a set-top box, copies of the plurality of stored images.

3. The image hosting service of claim 2, further comprising:
preventing access to the portion of the plurality of stored images and to the copies of the plurality of stored images after expiration of the limited period.

4. The image hosting service of claim 1, further comprising:
providing, through the digital television distribution network, an interface for the user to purchase for physical delivery to the user a hard copy of one or more of the stored images.

5. The image hosting service of claim 1, further comprising:
uploading the plurality of stored images to an image server.

6. The image hosting service of claim 1, wherein providing access to the portion of the plurality of stored images includes distributing the portion of the plurality of stored images to a plurality of set-top boxes at a location of the user.

7. The image hosting service of claim 6, further comprising:
disabling a recording feature of the plurality of set-top boxes.

8. The image hosting service of claim 1, wherein the stored images include still images of works of visual art, and wherein the image hosting service further comprises:
streaming, through the digital television distribution network, a video feed of a still image of a work of visual art from a first location of the work of visual art to a second location of a user.

9. A method of providing access to visual art through a digital television distribution network, the method comprising:
enabling a user of the digital television distribution network to select a work of visual art for display; and
providing the user access for a limited period to a stored electronic version of the selected work of visual art for the purpose of displaying a depiction of the work of visual art on a display that is communicatively coupled to a customer premises equipment.

10. The method of claim 9, further comprising:
providing an advertisement with the displayed depiction of the work of visual art.

11. The method of claim 9, further comprising:
charging, through a user account associated with the digital television distribution network, a fee to the user for access to the stored electronic version of the selected work of visual art.

12. The method of claim 9, further comprising:
providing a billing interface provisioned by a backend billing system for the digital television distribution network.

13. The method of claim 9, further comprising:
accumulating viewership statistics for a plurality of works of visual art viewed by a plurality of users; and
providing the viewership statistics to one or more rights management authorities associated with the works of visual art.

14. The method of claim 9, further comprising:
enabling the user to create a virtual gallery of the plurality of works of visual art selected by the user.

15. The method of claim 14, further comprising:
automatically presenting the user with choices for selectable works of visual art, wherein the choices for selectable works of visual art are based on an estimated taste of the user derived at least in part from comparing previous selections of the user with previous selections of other users.

16. The method of claim 15, further comprising randomizing an order in which depictions of works of visual art are accessed by a set-top box associated with the user.

17. The method of claim 15, further comprising providing the user a plurality of music selections for play during display of depictions of the works of visual art.

18. The method of claim 17, wherein the stored electronic version is based on a captured image of a plurality of works of visual art.

19. A set-top box enabled by instructions stored on a computer readable media, the computer readable instructions for:
presenting an electronic guide that includes a plurality of identifiers that correspond to a plurality of works of visual art available for access over a digital television network;
receiving a signal indicative of one or more of the plurality of identifiers selected by a user;
accessing electronic data representations of the plurality of works of visual art corresponding to the selected plurality of identifiers; and
enabling, for a limited period, the user to provide video signals to a display unit for displaying the plurality of works of visual art corresponding to the selected plurality of identifiers.

20. The set-top box of claim 19, wherein the computer readable media further comprises computer readable instructions for:
coordinating the display of multiple works of visual art with further set-top boxes at a user location.

21. The set-top box of claim 19, wherein the computer readable media further comprises computer readable instructions for:
presenting a plurality of music identifiers that correspond to a plurality of music works;
receiving a further user command to select one or more of the plurality of music identifiers for simultaneous play with the display of depictions of works of visual art; and
providing audio signals to a sound system for playing a portion of the plurality of music works simultaneously with the display of the depictions of works of visual art.

22. The set-top box of claim 19, wherein the electronic data includes streaming video captured from one or more works of visual art.
